(19) United States
(12) Patent Application Publication
(10) Pub. No.: US 2002/0066518 A1
(43) Pub. Date: Jun. 6, 2002

(54) Heat activitated splice kits for environmentally sealing electrical conductor splices and methods of using same

(76) Inventors: Rudolf Robert Bukovnik, Chapel Hill, NC (US); Jeffery Craig Judd, Wake Forest, NC (US)

Correspondence Address: Marguerite E. Gerstner, Tyco Electronics Corporation, Intellectual Property Law Department, 307 Constitution Drive, Mail Stop R20/1B, Menlo Park, CA, 94025-1164, US

(21) Appl. No.: 09/730,527

(22) Filed: Dec. 5, 2000

(51) Int. Cl. B32B 31/00

(52) U.S. Cl. 156/86; 156/304.6

(57) ABSTRACT

Splice kits and methods of environmentally sealing spliced electrical conductors are provided wherein exposure to sealant material can be eliminated. A sealed, flexible container, such as a bag, is provided that contains a two-part liquid sealant. Each portion of the two-part sealant is maintained within respective compartments of the sealed, flexible bag via a removable divider or other device. Prior to use, the divider is removed and the respective portions of the two-part sealant are mixed together by squeezing the sealed, flexible bag to produce a flowable, uncured sealant. The sealed, flexible bag is applied to an electrical conductor splice. The electrical conductor splice and sealed, flexible bag are then covered with heat shrinkable material. Heat is applied at a temperature sufficient to shrink the heat shrinkable material to a secure fit around the electrical conductor splice and to cause the sealed, flexible bag to at least partially melt and release the flowable, uncured sealant onto the electrical conductor splice. The sealant cures to provide structural support and environmental protection.

### FIELD OF THE INVENTION

The present invention relates generally to the interconnection of electrical conductors and, more particularly, to protecting interconnected electrical conductors from the environment.

### BACKGROUND OF THE INVENTION

Splicing of electrical conductors (whether for the transmission of telecommunications signals or electrical power) may be performed by removing an insulating coating on each conductor to be connected together, and connecting the bare conductors via a connection terminal, via fusion welding, etc. When electrical conductors are spliced together, it is often desirable to protect the splice from the environment (particularly moisture and contaminants), which can cause short-circuits or, in the case of signal transmission cables, deterioration of signal quality.

Cure-in-place sealants may be used to encapsulate a splice for environmental protection. In a pre-cured state, a cure-in-place sealant typically has a low viscosity (i.e., the sealant is flowable) allowing it to be poured around a splice. Typically, cure-in-place sealants are supplied in two-part liquid form that requires mixing by a technician in the field. After mixing the two parts together, the technician pours the sealant mixture into a cable splice. The sealant then cures to either a soft or hard consistency.

Unfortunately, this procedure may be messy and time consuming. Moreover, a technician may be exposed to sealant materials, which may be toxic or otherwise potentially harmful to the technician or to the environment. In addition, splicing methods utilizing conventional cure-in-place sealants may be wasteful because some of the sealant, once mixed, may remain unused.

### SUMMARY OF THE INVENTION

In view of the above discussion, splice kits and methods of environmentally sealing spliced electrical conductors are provided wherein exposure to the sealant can be reduced or even eliminated. According to an embodiment of the present invention, a method of environmentally sealing an electrical conductor splice includes providing a sealed, flexible container, such as a bag, that contains a two-part liquid sealant. Each portion of the two-part sealant is maintained within respective compartments of the sealed, flexible bag. The respective compartments are isolated via a removable divider. Prior to use, the divider is removed and the respective portions of the two-part sealant are mixed together by squeezing the sealed, flexible bag to produce a flowable, uncured sealant.

The sealed, flexible bag is positioned adjacent to an electrical conductor splice. The electrical conductor splice and sealed, flexible bag are then covered with heat shrinkable material. Heat is applied to the heat shrinkable material at a temperature sufficient to shrink the heat shrinkable material to a secure fit around the electrical conductor splice and also to cause the sealed, flexible bag to melt and release the flowable, uncured sealant onto the electrical conductor splice. The heat shrinkable material also helps to contain the flowable sealant therewithin.

Splice protector kits for environmentally sealing an electrical conductor splice, according to embodiments of the present invention, include a sealed, flexible bag containing a sealant, and heat shrinkable material that is configured to cover the electrical conductor splice and the sealed, flexible bag. The heat shrinkable material is configured to shrink to a secure fit around the electrical conductor splice when heated and to contain the flowable sealant therewithin.

In a splice protector kit, according to an embodiment of the present invention, the sealed, flexible bag includes first and second sealant portions that are isolated from each other within the container. The first and second sealant portions are maintained within respective compartments of the sealed, flexible bag. The respective compartments are isolated via a divider or other device that is removable to allow the first and second sealant portions to be mixed within the container, for example, by squeezing the container. The sealed, flexible bag is configured to at least partially melt when heat is applied to the heat shrinkable material to cause the heat shrinkable material to shrink.

According to other embodiments of the present invention, a flexible bag may be configured to rupture as a result of pressure from heat shrink material shrinking, thereby releasing a flowable sealant onto an electrical conductor splice.

According to other embodiments of the present invention, sealants that do not require pre-mixing may be utilized. For example, a sealed, flexible bag according to an embodiment of the present invention may contain a flowable sealant, such as grease and various cable filling and flooding compounds.

Splice kits and methods of environmentally sealing spliced electrical conductors, according to embodiments of the present invention, may be used with various types of electrical cables including, but not limited to, telecommunications cables and electrical power cables. Splice kits according to embodiments of the present invention may utilize fewer components than conventional splice kits, which may produce cost savings and which may facilitate faster installation times. Moreover, splice kits and methods of environmentally sealing spliced electrical conductors according to the present invention may be more environmentally sound than conventional cure-in-place sealing kits and methods because less waste material may be generated that requires disposal. Furthermore, splice kits and methods of environmentally sealing spliced electrical conductors according to the present invention may be less hazardous than conventional methods because technicians may not be directly exposed to sealant material.

### BRIEF DESCRIPTION OF THE DRAWINGS

FIG. 1 is a flow chart that illustrates steps for environmentally sealing an electrical conductor splice with a two-part flowable sealant, according to an embodiment of the present invention.

FIG. 2 is a flow chart that illustrates steps for environmentally sealing an electrical conductor splice with a flowable sealant, according to another embodiment of the present invention.

FIG. 3 is a plan view of a sealed, flexible bag containing first and second sealant portions in respective isolated compartments, according to an embodiment of the present invention, and wherein a removable divider is utilized to isolate the respective compartments.

FIG. 4 is a plan view of the sealed, flexible bag of FIG. 3 with the removable divider removed therefrom and with the first and second sealant portions mixed together.

FIG. 5 is an exploded, perspective view of two electrical cables having two respective conductors that are to be spliced together via respective connectors.

FIG. 6 is a perspective view of the respective electrical conductors of FIG. 5 spliced together.

FIG. 7 is a perspective view of the electrical conductor splice of FIG. 6 with the sealed, flexible bag of FIG. 4 being wrapped therearound, according to an embodiment of the present invention.

FIG. 8 is a perspective view of the electrical conductor splice of FIG. 6 with the sealed, flexible bag of FIG. 4 in an installed configuration.

FIG. 9 is a perspective view of the electrical conductor splice of FIG. 8 with heat shrinkable material surrounding the electrical conductor splice and sealed, flexible bag, according to an embodiment of the present invention.

FIGS. 10A-10B are perspective views of the electrical conductor splice of FIG. 9, wherein heat is being applied to the heat shrinkable material at the ends (FIG. 10A) and then at the middle (FIG. 10B) to cause the heat shrinkable material to shrink and to cause the sealed, flexible bag to melt thus allowing the sealant to flow onto the electrical conductor splice.

FIG. 11 is a cutaway, side elevation view of the sealed, flexible bag of FIG. 8 in an installed configuration around the electrical conductor splice and illustrating the sealant contained therewithin.

FIG. 12 is a cutaway, side elevation view of the heat shrinkable material of FIG. 9 illustrating the sealed, flexible bag wrapped around the electrical conductor splice.

FIGS. 13A-13B illustrate heat being applied to the heat shrinkable material of FIG. 12 at the ends (FIG. 13A) and then at the middle (FIG. 13B) to cause the heat shrinkable material to shrink and to cause the sealed, flexible bag to at least partially melt.

FIG. 14 illustrates that the sealed, flexible bag of FIG. 12 has melted, that the sealant has encapsulated the electrical conductor splice, and that the heat shrinkable material is retaining the sealant therewithin.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions may be exaggerated for clarity. Like numbers refer to like elements throughout the description of the drawings.

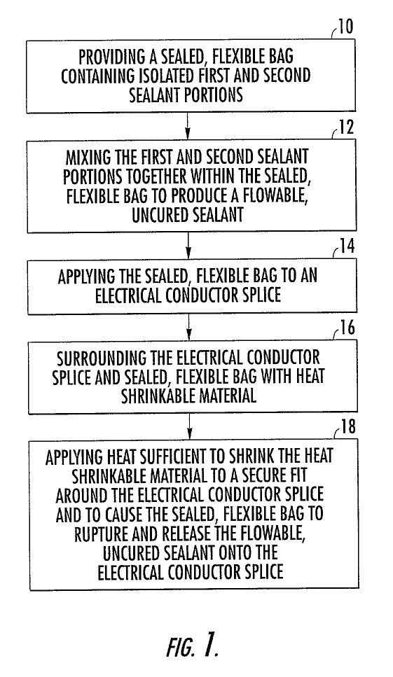

Referring now to FIG. 1, a method of environmentally sealing an electrical conductor splice with a two-part liquid sealant, according to an embodiment of the present invention, is illustrated. A sealed, flexible container, such as a bag, is provided that contains a first sealant portion and a second sealant portion (Block 10). The first and second sealant portions are maintained in isolation from each other prior to use. Preferably, the sealed, flexible bag includes a first compartment containing the first sealant portion and a second compartment containing the second sealant portion with a removable divider (or breakable seal or other mechanism) separating the first and second compartments. To produce a flowable, uncured sealant, the divider (or breakable seal or other mechanism) is removed and the first and second sealant portions are mixed together within the sealed, flexible bag (Block 12). Mixing of the first and second sealant portions may be accomplished by squeezing the sealed, flexible bag.

The sealed, flexible bag is applied to the electrical conductor splice (Block 14). For example, the flexible bag may be wrapped around the electrical conductor splice or a portion thereof. Next, the electrical conductor splice and the sealed, flexible bag are surrounded with heat shrinkable material (Block 16). Heat is then applied at a temperature sufficient to shrink the heat shrinkable material to a secure fit around the electrical conductor splice and to cause the sealed, flexible bag to at least partially melt (or rupture) and release the flowable, uncured sealant onto the electrical conductor splice (Block 18). The sealant is retained by the heat shrink material and allowed to cure to provide an environmental seal for the electrical conductor splice.

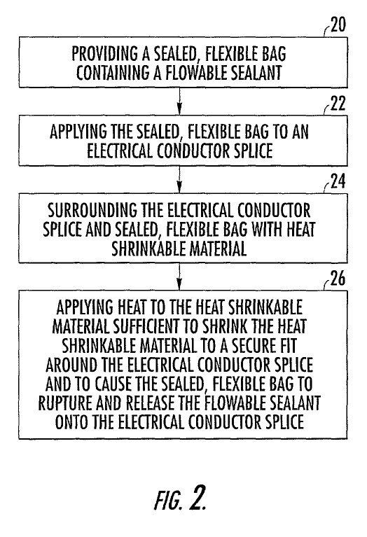

Referring now to FIG. 2, a method of environmentally sealing an electrical conductor splice with a flowable sealant, according to another embodiment of the present invention, is illustrated. A sealed, flexible container, such as a bag, is provided that contains a flowable sealant (Block 20). The sealed, flexible bag is applied to an electrical conductor splice (Block 22). For example, the flexible bag may be wrapped around the electrical conductor splice or a portion thereof. Next, the electrical conductor splice and the sealed, flexible bag are surrounded with heat shrinkable material (Block 24). Heat is then applied at a temperature sufficient to shrink the heat shrinkable material to a secure fit around the electrical conductor splice and to cause the sealed, flexible bag to at least partially melt (or rupture) and release the flowable, sealant onto the electrical conductor splice (Block 26). The sealant is retained by the heat shrink material and provides an environmental seal for the electrical conductor splice.

Referring now to FIG. 3, a sealed, flexible container 30 according to an embodiment of the present invention is illustrated. The illustrated sealed, flexible container 30 is a bag that includes first and second compartments 32, 34, each containing a respective first and second sealant portion 36, 38. A removable divider 40 (e.g., a clip or other clamping device) maintains isolation between the first and second compartments 32, 34. Upon removal of the divider 40, the first and second compartments 32, 34 are in communication with each other, thus allowing the first and second sealant portions 36, 38 to be mixed together.

According to other embodiments of the present invention, a weak adhesive may be utilized to maintain isolation between the first and second compartments 32, 34. The adhesive is configured to pull apart when the flexible container 30 is pressurized by squeezing to allow the first and second sealant portions 36, 38 to be mixed together.

Preferably, the sealed, flexible bag 30 is formed from material that is configured to melt when heated to a predetermined temperature or higher. Preferably, the sealed, flexible bag material is configured to melt entirely or substantially entirely when heated to a predetermined temperature. The sealed, flexible bag 30 can be formed from any suitable flexible impervious thermoplastic sheet material, such as, but not limited to, polyethylene, polyvinylchloride, ethyl vinyl acetate, or any one of numerous well known thermoplastic compositions. Also, the sealed, flexible bag 30 can have virtually any desired shape and configuration.

Commercially available two-part sealants which may be utilized in accordance with embodiments of the present invention include, but are not limited to, urethanes, epoxies, and silicones. An exemplary urethane is Biwax 628R/628C available from Biwax Corporation, Des Plaines, Ill. An exemplary epoxy is Biwax 118R/118C available from Biwax Corporation. An exemplary silicone is GE RTV6196 available from GE Silicones, Waterford, N.Y.

Sealants used in accordance with embodiments of the present invention preferably have high dielectric properties, are non-soluble in water, and are non-absorbent of atmospheric gases and commonly encountered airborne contaminants. Preferably, sealants used in accordance with embodiments of the present invention can provide structural support to a splice, and can provide vibration and shock dampening.

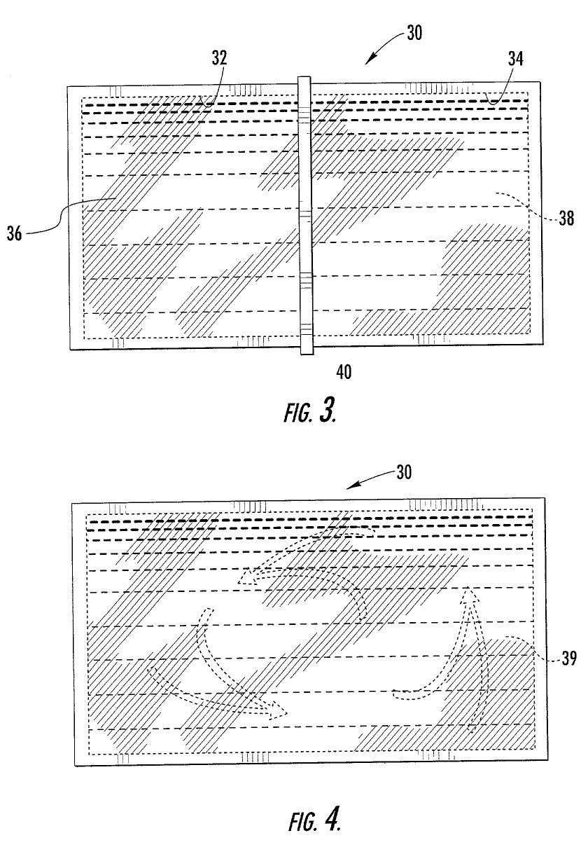

Referring now to FIG. 4, the removable divider 40 illustrated in FIG. 3 has been removed and the first and second sealant portions 36, 38 are mixed together within the sealed, flexible bag 30 to produce an uncured sealant 39. Mixing can be accomplished by hand by squeezing the sealed, flexible bag 30.

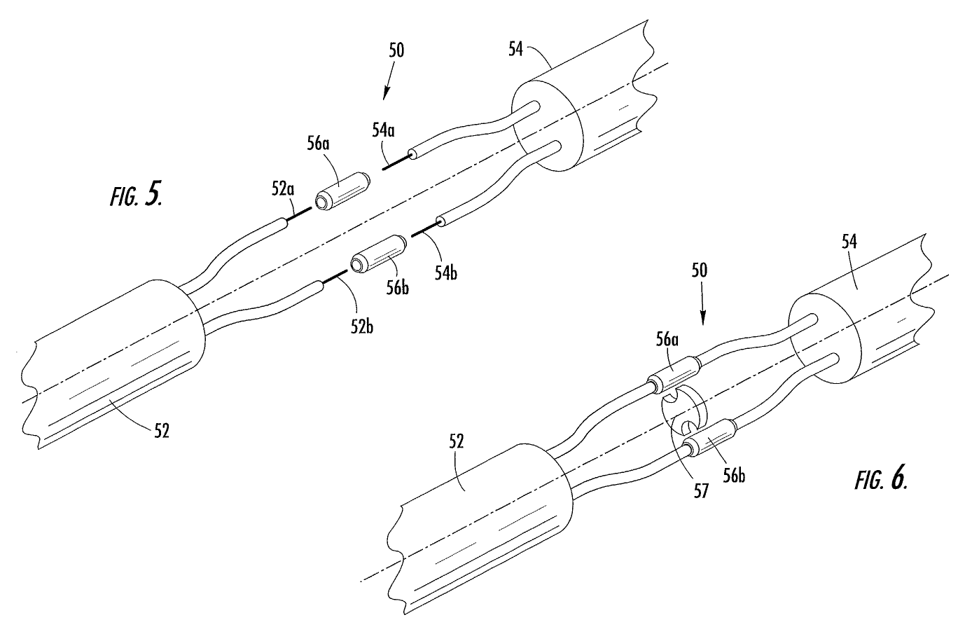

An exemplary electrical conductor splice 50 is illustrated in FIGS. 5 and 6. In the illustrated embodiment, two electrical conductors 52a, 52b from a first electrical cable 52 are spliced with respective electrical conductors 54a, 54b from a second electrical cable 54 via connectors 56a, 56b. A spacer 57 maintains electrical isolation between the connectors 56a, 56b, as would be understood by those of skill in the art.

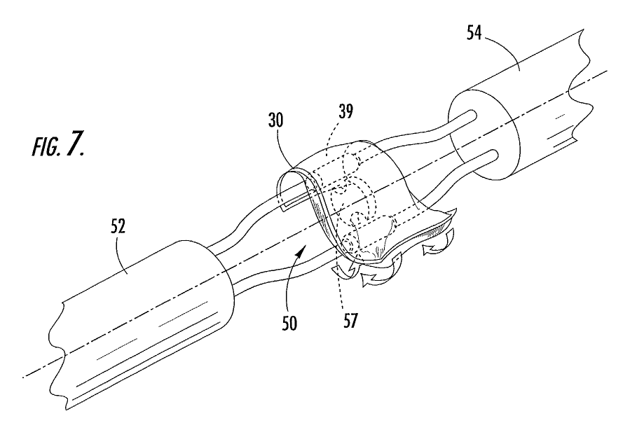

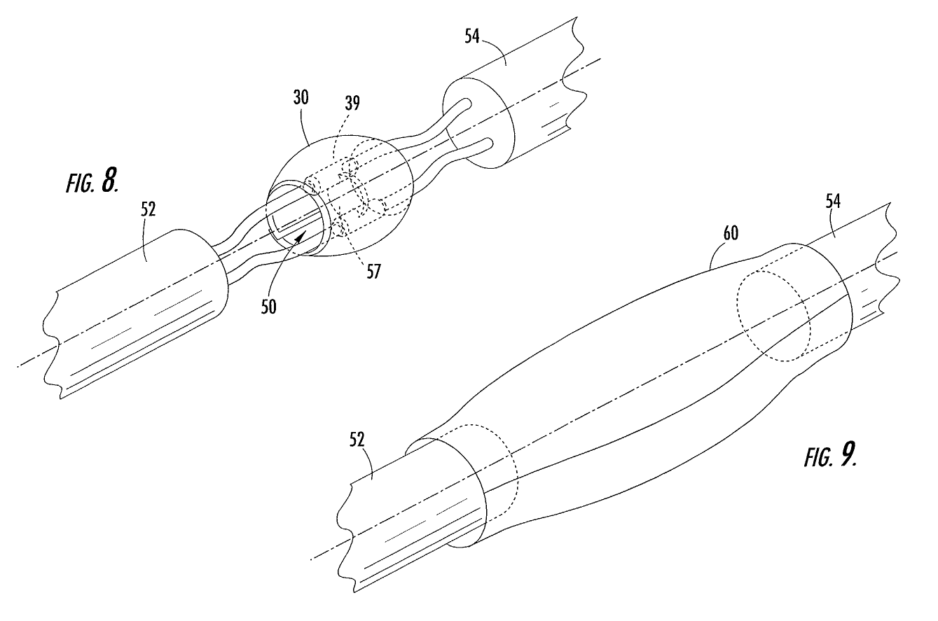

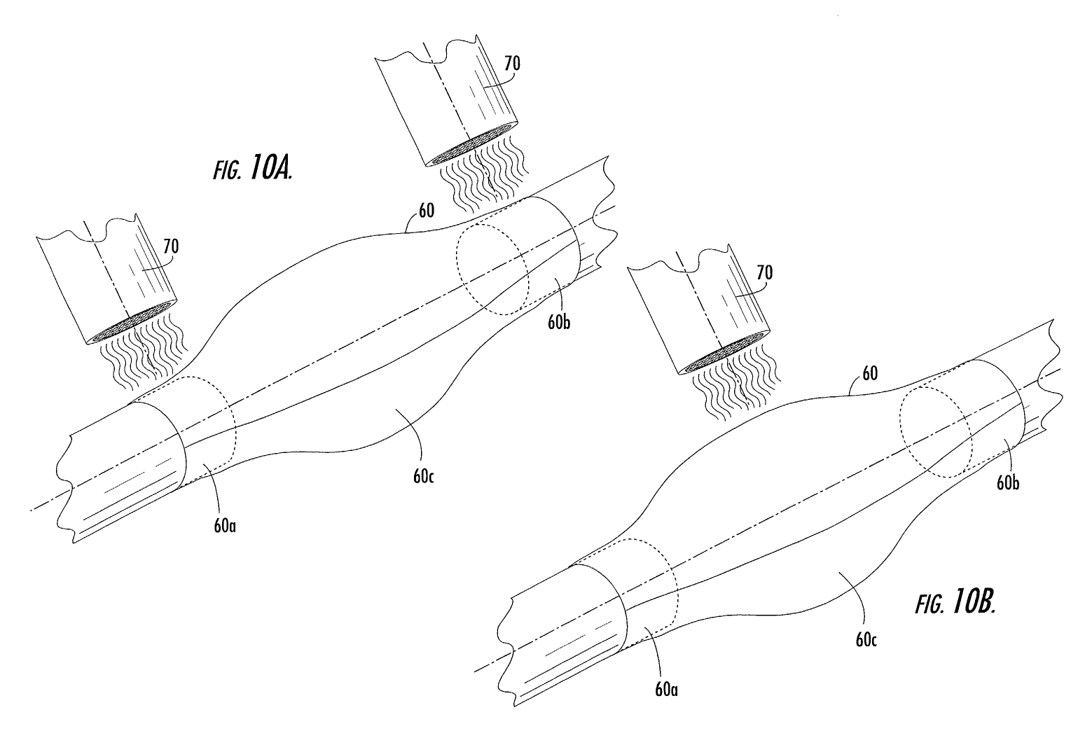

Referring now to FIGS. 7 and 8, the sealed flexible bag 30 of FIG. 4, with the uncured sealant 39 therein, is wrapped around at least a portion of the electrical conductor splice 50 of FIGS. 5 and 6. The splice 50 and the sealed, flexible bag 30 are then surrounded by heat shrink material 60, as illustrated in FIG. 9. The heat shrinkable material 60 is configured to shrink to a secure fit around the electrical conductor splice 50 when heated by a heat source 70 (FIGS. 10A-10B) to a temperature that causes the sealed flexible bag 30 to at least partially melt. As the heat shrinkable material 60 shrinks upon the application of heat, the uncured sealant 39 fills voids within the splice 50. Upon curing, the sealant 39 preferably becomes solid to provide structural support for the spliced electrical conductors and to provide an environmental seal.

Preferably, heat is applied to the ends 60a, 60b of the heat shrinkable material 60 first (FIG. 10A). Next, heat is applied to the middle portion 60c of the heat shrinkable material 60 (FIG. 10B) to cause the sealed flexible bag 70 to at least partially melt. By “shrinking” the ends 60a, 60b before the sealed flexible bag 70 melts, the sealant can be prevented from being squeezed out between the cables 52, 54 and the heat shrinkable material 60.

Numerous suitable heat shrinkable materials may be used in accordance with the present invention and are known to those skilled in the art. For example, crystalline polymers such as polyolefins, including polyethylene, ethylene-vinyl acetate copolymer, ethylene-vinyl acrylate copolymer or other ethylene copolymers, polyvinylide difluoride, polyvinyl chloride, and the like, whether cross-linked or inherently heat recoverable. Other suitable heat shrinkable materials include, but are not limited to, thermoplastic elastomers such as thermoplastic polyurethanes and silicone-styrene block copolymers.

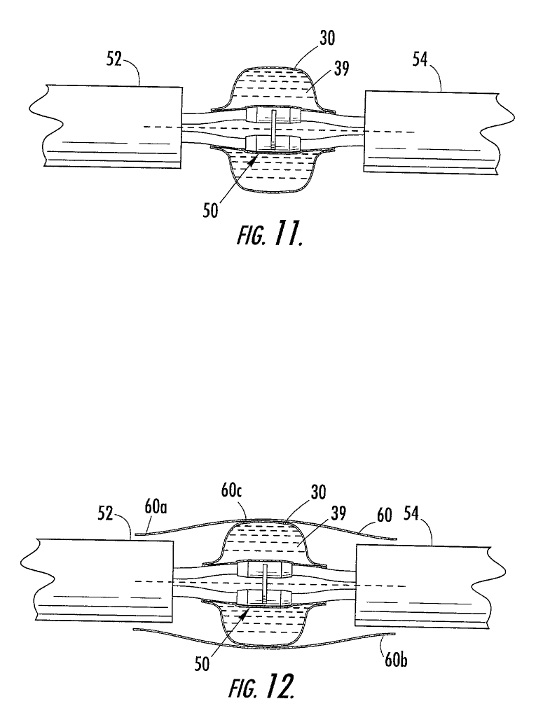

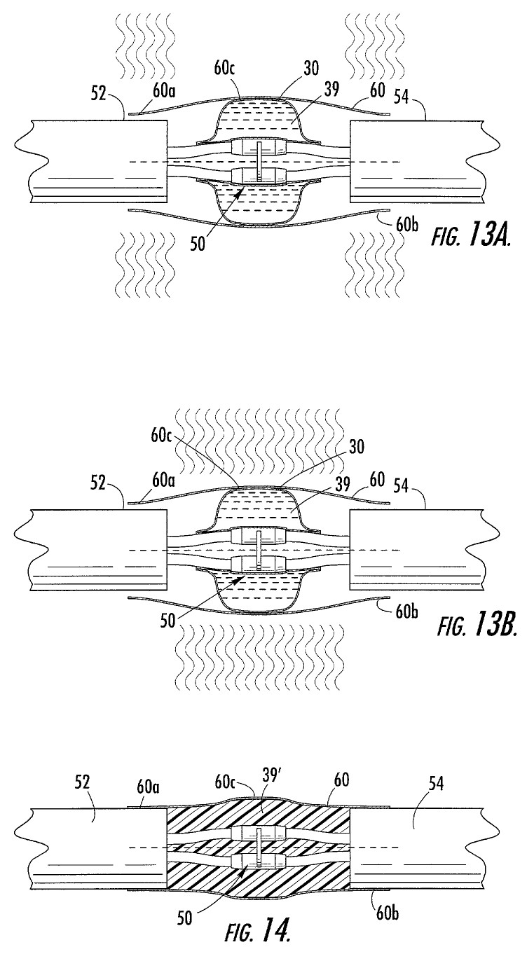

Referring now to FIGS. 11-14, a cutaway view of the sealed, flexible bag 30 of FIG. 4 is illustrated in various stages of environmentally sealing the electrical conductor splice 50 of FIG. 6. In FIG. 11, the sealed, flexible bag 30 is wrapped around the splice 50. In FIG. 12, heat shrinkable material 60 is wrapped around the electrical conductor splice 50 and sealed, flexible bag 30. In FIGS. 13A-13B, heat is applied to the heat shrinkable material at the ends 60a, 60b (FIG. 13A) and then at the middle (FIG. 13B) to cause the heat shrinkable material 60 to shrink and to cause the sealed, flexible bag 30 to at least partially melt or rupture. In FIG. 14, the heat shrinkable material 60 has been reduced in size to form a secure fit around the electrical conductor splice 50. The applied heat has also caused the sealed, flexible bag 30 to at least partially melt, thereby allowing the uncured sealant 39 to escape therefrom onto the electrical conductor splice 50. In the illustrated embodiment, the applied heat has caused the sealed, flexible bag to melt or dissolve entirely. Also in FIG. 14, the uncured sealant has cured to form a cured encapsulant 39′. The heat shrinkable material 60 retains the cured encapsulant 39′ therewithin.

Alternative embodiments of the present invention may utilize various flowable sealants that are not in two-part form, and that do not require a sealed flexible bag having separate compartments. Exemplary flowable sealants that may be used in accordance with such embodiments of the present invention include, but are not limited to greases, cable filling compounds and cable flooding compounds. Exemplary cable filling compounds are absorbent, thixotropic gels, such as Waterguard available from Waterguard Cable Products, Inc., Houston, Tex., and Witogel II, available from Witco Corporation, Petrolia, Pa. Other exemplary cable filling compounds are described in U.S. Pat. Nos. 4,724,277; 4,716,191; 5,728,754; 5,218,011; and 5,256,705. Exemplary cable flooding compounds are described in U.S. Pat. Nos. 5,306,867; 5,049,593; 5,179,611; 5,335,302; and 5,285,513.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of environmentally sealing an electrical conductor splice, comprising:
providing a sealed, flexible container containing a first sealant portion and a second sealant portion, wherein the first and second sealant portions are isolated from each other;
mixing the first and second sealant portions together within the sealed, flexible container to produce a flowable, uncured sealant;
applying the sealed, flexible container to the electrical conductor splice;
covering the electrical conductor splice and sealed, flexible container with heat shrinkable material; and
applying heat sufficient to shrink the heat shrinkable material around the electrical conductor splice and to cause the sealed, flexible container to at least partially melt and release the flowable, uncured sealant onto the electrical conductor splice.

2. The method according to claim 1, wherein the sealed, flexible container includes a first compartment containing the first sealant portion and a second compartment containing the second sealant portion, wherein the first and second compartments are isolated via a removable divider, and wherein the step of mixing the first and second sealant portions together is preceded by the step of removing the divider.

3. The method according to claim 1, wherein the step of mixing the first and second sealant portions together comprises mixing the first and second sealant portions together within the sealed, flexible container by squeezing the sealed, flexible container.

4. The method according to claim 1, wherein the sealed, flexible container comprises material selected from the group consisting of polyethylene, ethyl vinyl acetate, polypropylene, and styrene.

5. The method according to claim 1, wherein the sealed, flexible container comprises material having a melting point at or below a temperature that causes the heat shrinkable material to shrink when heat is applied thereto.

6. The method according to claim 1, wherein the first sealant portion comprises a resin selected from the group consisting of epoxies, silicones, urethanes, and polyesters, and wherein the second sealant portion comprises a hardener.

7. A splice protector kit for environmentally sealing an electrical conductor splice, comprising:
a sealed, flexible container containing a first sealant portion and a second sealant portion, wherein the first and second sealant portions are isolated from each other, and wherein the sealed, flexible container is configured to at least partially melt at a predetermined temperature; and
heat shrinkable material configured to cover a conductor splice and the sealed, flexible container, wherein the heat shrinkable material is configured to shrink around the electrical conductor splice when heated to a temperature that is equal to or greater than the predetermined temperature.

8. The splice protector kit according to claim 7, wherein the sealed, flexible container includes a first compartment containing the first sealant portion and a second compartment containing the second sealant portion, and wherein the first and second compartments are isolated via a removable divider.

9. The splice protector kit according to claim 7, wherein the sealed, flexible container comprises material selected from the group consisting of polyethylene, ethyl vinyl acetate, polypropylene, and styrene.

10. The splice protector kit according to claim 7, wherein the sealed, flexible container comprises material having a melting point at or below a temperature that causes the heat shrinkable material to shrink when heat is applied thereto.

11. The splice protector kit according to claim 7, wherein the first sealant portion comprises a resin selected from the group consisting of epoxies, silicones, urethanes, and polyesters, and wherein the second sealant portion comprises a hardener.

12. A method of environmentally sealing an electrical conductor splice, comprising:
providing a sealed, flexible container containing a flowable sealant;
applying the sealed, flexible container to the electrical conductor splice;
covering the electrical conductor splice and sealed, flexible container with heat shrinkable material; and
applying heat to the heat shrinkable material sufficient to shrink the heat shrinkable material to a secure fit around the electrical conductor splice and to cause the sealed, flexible container to at least partially melt and release the flowable sealant onto the electrical conductor splice.

13. The method according to claim 12, wherein the sealed, flexible container comprises material selected from the group consisting of polyethylene, ethyl vinyl acetate, polypropylene, and styrene.

14. The method according to claim 12, wherein the sealed, flexible container comprises material having a melting point at or below a temperature that causes the heat shrinkable material to shrink when heat is applied thereto.

15. The method according to claim 12, wherein the flowable sealant is selected from the group consisting of greases, cable filling compounds, and cable flooding compounds.

16. A splice protector kit for environmentally sealing an electrical conductor splice, comprising:
a sealed, flexible container containing a flowable sealant, wherein the sealed, flexible container is configured to at least partially melt at a predetermined temperature and allow the flowable sealant to escape therefrom; and
heat shrinkable material configured to cover a conductor splice and the sealed, flexible container, wherein the heat shrinkable material is configured to shrink around the electrical conductor splice when heated to a temperature that is equal to or greater than the predetermined temperature.

17. The splice protector kit according to claim 16, wherein the sealed, flexible container comprises material selected from the group consisting of polyethylene, ethyl vinyl acetate, polypropylene, and styrene.

18. The splice protector kit according to claim 16, wherein the sealed, flexible container comprises material having a melting point at or below a temperature that causes the heat shrinkable material to shrink when heat is applied thereto.

19. The splice protector kit according to claim 16, wherein the flowable sealant is selected from the group consisting of greases, cable filling compounds, and cable flooding compounds.
